(19) United States
(12) Patent Application Publication
(10) Pub. No.: US 2004/0173062 A1
(43) Pub. Date: Sep. 9, 2004

(54) Military tool and associated methods

(76) Inventor: Leonard J. DeFrancisci, West Melbourne, FL (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/383,601

(22) Filed: Mar. 7, 2003

(51) Int. Cl. B25B 1/00

(52) U.S. Cl. 81/488

(57) ABSTRACT

A multifunctional, portable tool has a generally cylindrical elongate body. The body has a male portion at the body first end having a first mating element adjacent the first end. The male portion tapers toward the first end. The body also has a female portion at the body's second end that has an axial bore extending from an opening at the body's second end. A second mating element is positioned within the bore, which is adapted to mate with the first mating element. The bore has a diameter sufficient to admit at least part of the male portion. In one embodiment, the male portion of the first tool is retained within the bore of the second tool by a friction fit. In a second embodiment, the male and female portions mate via a screw thread and groove.

### BACKGROUND OF THE INVENTION

1. Field of the Invention

The present invention relates to military tools, and, more particularly, to such tools that have multiple purposes and are lightweight and readily portable in the field.

2. Description of Related Art

When deployed in the field, military personnel such as a soldier or Marine must carry tools for performing a multiplicity of functions. During operations, it is important that such tools be dependable, lightweight, and compact. Therefore, a single tool that is multifunctional is desirable.

Tent poles are known that are assembled from a plurality of sections collinearly. However, such poles when assembled have neither sufficient strength nor security to perform the multiple functions contemplated by the present invention.

### SUMMARY OF THE INVENTION

The present invention addresses the need for a multifunctional, portable tool. A first embodiment of the tool comprises an elongate body having a first end and a second end opposed to the first end. The body has a male portion at the body first end having a first mating means adjacent the first end. The male portion tapers toward the first end.

The body also has a female portion at the body's second end that has an axial bore extending from an opening at the body's second end. A second mating means is positioned within the bore, the second mating means being adapted to mate with the first mating means. The bore has a diameter sufficient to admit at least part of the male portion.

In a first embodiment, the male portion of the first tool is retained within the bore of the second tool by a friction fit.

A second embodiment of the tool comprises a generally cylindrical elongate body having a first end and a second end opposed to the first end. The tool has a male portion that extends from the body's first end and has a diameter smaller than the body's diameter. The male portion also has a longitudinal axis that is generally collinear with a longitudinal axis of the body. Further, the male portion has a male threaded section that is adjacent an inner end, and tapers toward an outer end.

The tool also has a diametric hole located adjacent the second end. The hole extends generally perpendicular to the body's longitudinal axis. A bore extends from an opening at the body's second end and has a female threaded section. The bore has a diameter larger than the male portion's diameter.

A method of using a multifunction tool of either embodiment comprises the steps of providing a plurality of tools as described above, and mating the bore of a first tool with a male portion's threaded section of a second tool. Then the male portion of the first tool is inserted into the ground, and a fabric is draped over the second tool's second end for providing shelter and concealment.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a side perspective view of a first embodiment of the tool of the present invention.

FIG. 2 is a side perspective view of a second embodiment of the tool of the present invention.

FIG. 3 is another side perspective view of the second embodiment of the tool, rotated 90° from the view of FIG. 2.

FIG. 4 is an illustration of the tool being used to support a shelter drape.

FIG. 5 is an illustration of the tool being used to form a stretcher.

FIG. 6 is an illustration of the tool being used to define lateral firing limits.

FIG. 7 is an illustration of the tool being used as a land mine probe.

FIG. 8 is an illustration of the tool being used as a handle for a hammer.

### DETAILED DESCRIPTION OF THE PREFERRED EMBODIMENTS

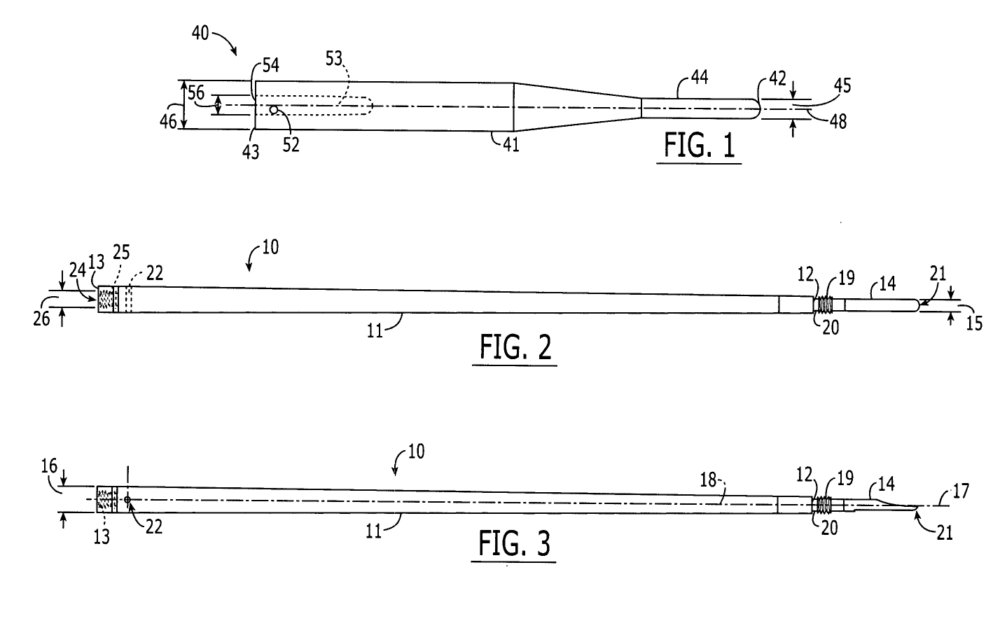

A description of the preferred embodiments of the present invention will now be presented with reference to FIGS. 1-8.

A first embodiment of a multifunctional tool 40 (FIG. 1) of the present invention, which is believed to represent the best mode at the present time, comprises an elongate body 41 that has a first end 42 and a second end 43 that is opposed to the first end 42. The body 41 has a male portion 44 that extends from the body's first end 42 and has a diameter 45 that is smaller than that 46 adjacent the second end 43. The body 41 tapers outward toward the second end 43 to the second diameter 46, the taper occurring at approximately the midpoint of the body 41, although this is not intended as a limitation. Further, the male portion 44 has a downward taper toward the first end 42.

The tool 40 also has a diametric hole 52 located adjacent the second end 43. The hole 52 extends generally perpendicular to the body's longitudinal axis 48. This hole 52 may be used, for example, to secure a line. An axial bore 53 extends from an opening 54 at the body's second end 43. The bore 53 has a diameter 56 larger than the male portion's diameter 45. This embodiment of the tool 40 is intended to mate by inserting a male portion 44 of a first tool 40 into a bore 53 of a second tool 40, with a frictional fit.

A second embodiment of a multifunctional, portable tool 10 of the present invention (FIGS. 2 and 3) comprises a generally cylindrical elongate body 11 that has a first end 12 and a second end 13 that is opposed to the first end 12. The tool 10 has a male portion 14 that extends from the body's first end 12 and has a diameter 15 that is smaller than the body's diameter 16. The male portion 14 also has a longitudinal axis 17 that is generally collinear with a longitudinal axis 18 of the body 11. Further, the male portion 14 has a male threaded section 19 that is adjacent an inner end 20, and tapers toward an outer end 21, as, for example, in a “scooped” configuration, although this is not intended as a limitation, and one of skill in the art will recognize that a pointed configuration is also embodied by the present invention.

The tool 10 also has a diametric hole 22 located adjacent the second end 13. The hole 22 extends generally perpendicular to the body's longitudinal axis 18. This hole 22 may be used, for example, to secure a line such as parachute cord, or a nylon all-purpose cord. An axial bore 23 extends from an opening 24 at the body's second end 13 and has a female threaded section 25. The bore 23 has a diameter 26 larger than the male portion's diameter 15. In a particular embodiment (not shown) the bore 23 extends from the body's first end 12 through to the male portion's outer end 21.

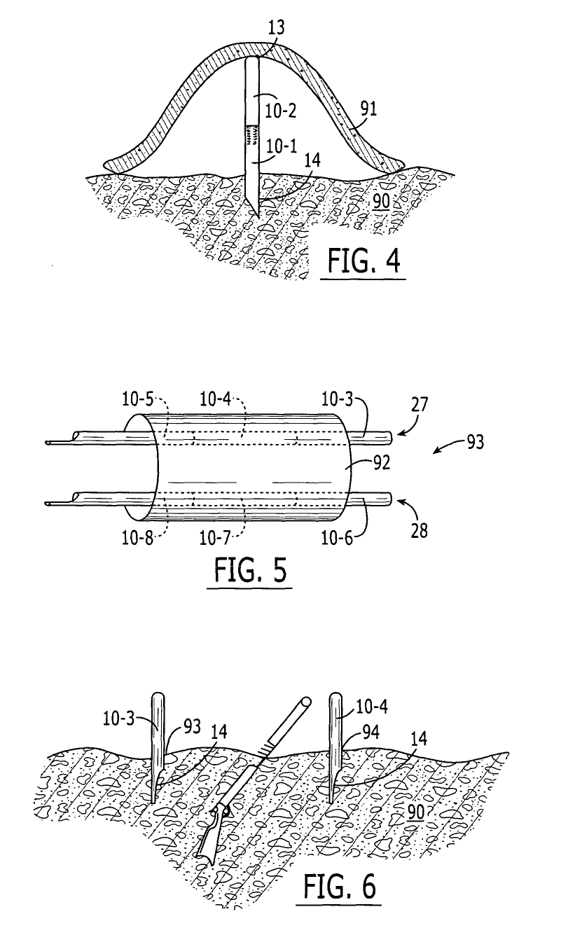

A first method of using a multifunctional tool 10 (FIG. 4) comprises the steps of providing a plurality of tools 10 as described above, and mating the bore 23 of a first tool 10-1 with a male portion's threaded section 19 of a second tool 10-2. Then the male portion 14 of the first tool 10-1 is inserted into the ground 90, and a fabric 91 is draped over the second tool's second end 13 for providing shelter and concealment. For example, a camouflage net could be supported. Similarly, a solar still can be formed with several tools 10 joined together to form a pole to support a fabric such as a poncho liner to collect water in the desert.

A second method of the present invention (FIG. 5) comprises the steps of mating the male threaded section 19 of a third tool 10-3 with the female threaded section 25 of a fourth tool 104, and mating the male threaded section 19 of the fourth tool 10-4 with the female threaded section 25 of a fifth tool 10-5 to make a first pole 27. Similarly, a second pole 28 is made by mating a sixth 10-6, a seventh 10-7, and an eighth 10-8 tool together. Next a fabric 92 such as a poncho liner is affixed between the first 27 and the second 28 pole to create a carrying stretcher 93.

A third method of the present invention (FIG. 6) employs the tool as an aiming stake for designating a sector of rifle fire, and comprises the steps of driving the male portion 14 of a third tool 10-3 into the ground 90 at a first location 93 to designate a left lateral limit of a sector of fire and driving the male portion 14 of a fourth tool 10-4 into the ground 90 at a second location 94 spaced apart from the first location 93 to designate a right lateral limit of the sector of fire.

In a fourth method of the present invention (FIG. 7), the tool 10 comprises a nonmagnetic material. This method comprises the step of inserting the male portion 14 of a third tool 10-3 into the ground 90 to probe for a land mine 95. Since the tool 10 comprises a nonmagnetic material, it will not detonate a magnetic land mine 95.

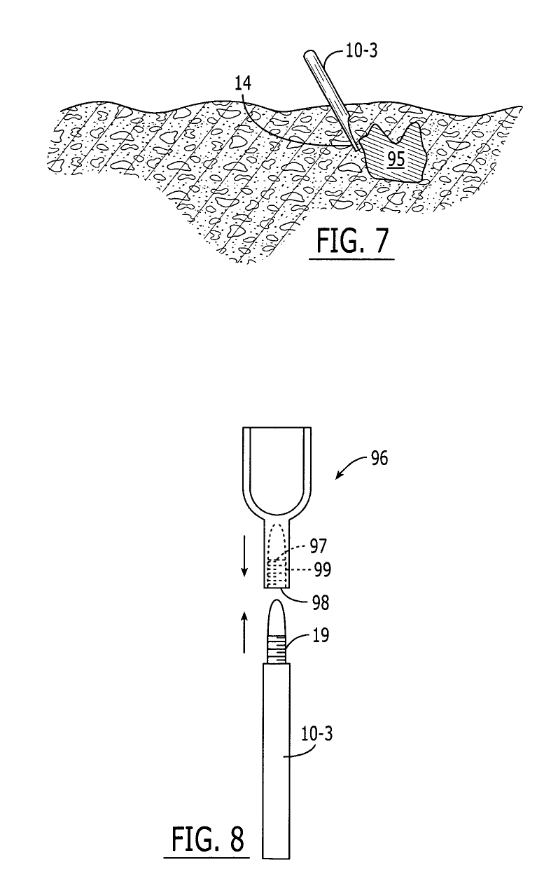

In a fifth method of the present invention (FIG. 8), a tool head 96 is provided that has a bore 97 extending into the tool head 96 from a lower end 98 of the tool head 96 and has a threaded section 99. In this method the tool head's threaded section 99 is screwingly mated with the male threaded section 19 of a third tool 10-3. Such a tool head 96 may comprise, for example, a hammer head, a shovel, or a hatchet.

In the embodiment wherein the bore 23 extends from the body's second end 12 through to the male portion's outer end 21, the tool 10 can also be used as an underwater breathing apparatus. The tool 10 can also be used as a weapon, either singly or joined with other tools 10, using the pointed end 21 as a spear point. Other possible uses include poles for forming a ladder, a splint, a walking stick, and a tripod.

It will be apparent to one of skill in the art that the first embodiment of the tool 40 can be used to achieve the methods as recited above with reference to FIGS. 4-8.

In a preferred embodiment, the tool 10,40 comprises one of a corrosion-resistant nonmagnetic metal alloy, aircraft aluminum, stainless steel, plastic, and titanium, or a combination thereof. Exemplary dimensions include a length of 2 feet and a diameter of 0.75 in. When used as a military tool, it is envisioned that a set of three be issued to each soldier or Marine.

It may be appreciated by one skilled in the art that additional embodiments may be contemplated, including alternate mating means such as bayonet mounts and snap-fit means. Another possible mating means comprises the male end of the tool having a pair of spiral grooves therein, for mating with a corresponding pair of protrusions on the female end, or vice versa. Thus the invention is not intended to be limited to a threaded or friction-fit mating means as discussed in detail above.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A method of using a multifunction tool comprising the steps of:
providing a plurality of tools, each tool comprising an elongate body having a first end and a second end opposed to the first end, the body having:
a male portion at the body first end having a first mating means adjacent the first end, the male portion tapering toward the first end;
a female portion at the body second end having an axial bore extending from an opening at the body second end, and a second mating means positioned within the bore, the second mating means adapted to mate with the first mating means, the bore having a diameter sufficient to admit at least part of the male portion;
mating the second mating means of a first tool with a first mating means of a second tool;
inserting the male portion of the first tool into ground; and
draping a fabric over the second tool second end for providing shelter and concealment.

2. The method recited in claim 1, wherein the male portion of the first tool is retained within the bore of the second tool by a friction fit.

3. The method recited in claim 1, further comprising the steps of:
mating the first mating means of a third tool with the second mating means of a fourth tool;
mating the first mating means of the fourth tool with the second mating means of a fifth tool to make a first pole;
mating the first mating means of a sixth tool with the second mating means of a seventh tool;
mating the first mating means of the seventh tool with the second mating means of an eighth tool to make a second pole; and
draping a fabric between the first and the second pole to create a carrying stretcher.

4. The method recited in claim 1, further comprising the steps of:
driving the male portion of a third tool into ground at a first location to designate a left lateral limit of a sector of fire; and
driving the male portion of a fourth tool into ground at a second location spaced apart from the first location to designate a right lateral limit of the sector of fire.

5. The method recited in claim 1, wherein the tool comprises a nonmagnetic material, and further comprising the step of inserting the male portion of a third tool into ground to probe for a magnetic land mine.

6. The method recited in claim 1, further comprising the step of affixing a tool head to a third tool, the tool head having a bore extending from a lower end of the tool head, the tool head bore having mating means matable with the third tool first mating means, the tool head bore adapted to admit at least a part of the male portion on the third tool.

7. The method recited in claim 1, wherein the bore extends from the body first end through to the body second end.

8. The method recited in claim 1, wherein the tool comprises one of aircraft aluminum, stainless steel, plastic, a corrosion-resistant nonmagnetic metal alloy, and titanium.

9. A method of using a multifunction tool comprising the steps of:
providing a plurality of tools, each tool comprising a generally cylindrical elongate body having a first end and a second end opposed to the first end, each tool having:
a male portion extending from the body first end having a diameter smaller than a diameter of the body and having a longitudinal axis generally collinear with a longitudinal axis of the body, the male portion having a male threaded section adjacent an inner end and tapering toward an outer end;
a diametric hole adjacent the second end extending generally perpendicular to the body longitudinal axis; and
an axial bore extending from an opening at the body second end and having a female threaded section, the bore having a diameter larger than the male portion diameter;
mating the bore of a first tool with a male portion threaded section of a second tool;
inserting the male portion of the first tool into ground; and
draping a fabric over the second tool second end for providing shelter and concealment.

10. The method recited in claim 9, further comprising the steps of:
mating the male threaded section of a third tool with the female threaded section of a fourth tool;
mating the male threaded section of the fourth tool with the female threaded section of a fifth tool to make a first pole;
mating the male threaded section of a sixth tool with the female threaded section of a seventh tool;
mating the male threaded section of the seventh tool with the female threaded section of an eighth tool to make a second pole; and
draping a fabric between the first and the second pole to create a carrying stretcher.

11. The method recited in claim 9, further comprising the steps of:
driving the male portion of a third tool into ground at a first location to designate a left lateral limit of a sector of fire; and
driving the male portion of a fourth tool into ground at a second location spaced apart from the first location to designate a right lateral limit of the sector of fire.

12. The method recited in claim 9, wherein the tool comprises a nonmagnetic material, and further comprising the step of inserting the male portion of a third tool into ground to probe for a magnetic land mine.

13. The method recited in claim 9, further comprising the step of affixing a tool head to a third tool, the tool head having a bore extending from a lower end of the tool head, the tool head bore having a threaded section screwingly matable with the third tool male threaded section, the tool head bore adapted to admit at least a part of the male portion on the third tool.

14. The method recited in claim 9, wherein the bore extends from the body first end through to the male portion outer end.

15. The method recited in claim 9, wherein the tool comprises one of aircraft aluminum, stainless steel, plastic, a corrosion-resistant nonmagnetic metal alloy, and titanium.
